(19) United States
(12) Patent Application Publication
(10) Pub. No.: US 2018/0313479 A1
(43) Pub. Date: Nov. 1, 2018

(54) COUPLING SYSTEM AND A METHOD FOR COUPLING TWO PIPE ENDS

(71) Applicant: Wavin B.V., Zwolle (NL)

(72) Inventors: Earnst Korné Brinkhuis, Zwolle (NL); Joseph M. Venegas, Zwolle (NL)

(73) Assignee: Wavin B.V., Zwolle (NL)

(21) Appl. No.: 15/771,589

(22) PCT Filed: Oct. 28, 2016
(86) PCT No.: PCT/EP2016/076123

§ 371 Date: Apr. 27, 2018

(30) Foreign Application Priority Data
Oct. 30, 2015 (NL) 1041552

(51) Int. Cl. F16L 21/08; F16L 21/06; F16L 27/00; F16L 21/03

(52) U.S. Cl. CPC F16L 21/08; F16L 21/03; F16L 27/00; F16L 21/06

(57) ABSTRACT

A coupling system for coupling two pipe ends (2, 3) which are each provided with an outer wall (21, 31) and, at at least one circumferential position on the outer wall (21, 31), a protrusion (20, 30) that extends radially outwardly, comprises a frame (10) which can adopt an open condition and a closed condition, the open condition allows the frame (10) to be put around the two pipe ends (2, 3) when put together for a continuation of a pipeline lumen, the frame (10) in the closed condition being configured to house the two pipe ends (2, 3) when put together for a continuation of the pipeline lumen, wherein the frame (10) comprises at least a first and a second restrictor part (11, 12), the first and second restrictor parts (11, 12) being configured to allow an abutment against the protrusions (20) of the opposite pipe ends (2) in the closed condition of the frame (10), so that the pipe ends (2, 3) are at least limited from moving away from each other in a pipeline direction by inability of the protrusions (20, 30) to pass beyond the first and second restrictor parts (11, 12), respectively.

This invention relates to coupling systems for coupling two pipe ends, for example pipe ends of large diameter pipes such as PVC plastic pipes for transporting and distributing a fluid such as water or gas.

During transportation of a fluid the pressure in a pipe transporting the fluid may be high. Consequently, high stress loads may act on the pipe walls and on a coupling system coupling the pipe ends. In addition, also the surrounding of the pipes may generate loads acting on the coupled pipe ends and on the coupling system. This occurs, for example, when a pipe is buried in soil and the soil moves. Tensile loads acting on the pipe ends and/or on the coupling system may pull a pipe end and the coupling system apart.

In order to prevent the pipe ends and the coupling system from being pulled apart, it is known to fixedly mount the coupling system to the pipe ends. The fixation can be realized mechanically or by using an adhesive and/or a solvent agent. However, mechanical fixations may have a complex shape, a complicated working principle, and may require that their parts are manufactured with high precision. This leads to high manufacturing costs. At the same time, it would be preferable to avoid the use of adhesives and solvent agents for certain pipe systems, such as transportation systems for potable water, so as to avoid any contamination and to reduce the work required for installation of a pipe system.

DE 9113612 U1 discloses a pipe coupling system including a radial clamping mechanism. To couple two socketed pipe ends, a support tube is inserted in-between the pipe ends, and the ends are then radially clamped onto the support tube using locking members inserted into corresponding holes. To increase the radial clamping force, a clamping sleeve may be further mounted onto the connection part. However, the tightening of the radial clamping mechanism may be time-consuming, and the separation of a pipe end from the coupling system may not be sufficiently prevented.

It is an object of the present invention to provide a coupling system and a corresponding method of use of a coupling system which addresses at least one of the previously-described shortcomings.

Embodiments of the present invention are defined by the claims below.

### GENERAL DESCRIPTION

According to one aspect, there is provided a coupling system for coupling two pipe ends which are each provided with an outer wall and, at at least one circumferential position on the outer wall, a protrusion that extends radially outwardly. The system comprises a frame, which can adopt an open condition and a closed condition. The open condition allows the frame to be put around the two pipe ends when put together for a continuation of a pipeline lumen. The frame in the closed condition is configured to house the two pipe ends when put together for a continuation of the pipeline lumen. The frame further comprises at least a first and a second restrictor part, the first and second restrictor parts being configured to allow an abutment against the protrusions of the opposite pipe ends in the closed condition of the frame, so that the pipe ends are at least limited in moving away from each other in a pipeline direction by inability of the protrusions to pass beyond the first and second restrictor parts, respectively.

Embodiments of the coupling system are configured for use with pipe ends on which the protrusions on the circumferential position on the outer wall are provided at the same distance from their respective rims. Other embodiments are configured for use with pipe ends on which the protrusions on the circumferential position on the outer wall are provided at different. distances from their respective rims. The positions of the restrictor parts can be adapted accordingly, to be compatible with the positions of the protrusions on the pipe ends. When referring to the radially outwardly extending protrusion, the term, ‘radially’ pertains to the radius of the pipe end. The protrusion need not be oriented in the radial direction itself, but merely needs to comprise a component in the radial direction.

The first and second restrictor parts may be formed integrally as one piece, or they can be provided as separate members. The first and second restrictor parts can be integral parts of the frame or one or both of them can be provided separately from the frame. The first restrictor part allows abutting against the first protrusion of a first pipe end, while the second restrictor part allows abutting against a second protrusion of a second pipe end.

An abutment between a restrictor part and a pipe end protrusion may be continuously realized in the closed condition of the frame. Alternatively, the abutment may merely be realized at times, for example when the pipe ends have moved away from each other up to a maximum extent, i.e. to the point when the protrusions hit the restrictor parts. In other words, the coupling system may allow for some relative movement between the pipe ends, but the pipe ends are then hindered from moving away from each other in the pipeline direction beyond a maximum extent.

The pipe ends moving away from each other may involve movements while the pipe ends are spatially separated and/or movements while they are in contact. The latter may for example be the case when one of the pipe ends is inserted into the other one, such that they overlap. A prevention of a movement away from each other may also be realized in this overlapping state.

The pipeline direction at every location refers to the local direction of the pipeline lumen. When the pipe ends and the coupling system are straight, this pipeline direction may be the same direction along the entire coupling system, but the pipeline direction may also vary locally, for example, when the coupling system forms a C-shaped coupling. In the latter case, the pipeline direction may form a tangent direction to the local axial direction of the pipe ends or of a part of the coupling system between the pipe ends.

Because the frame of the coupling system can adopt an open and a closed condition, two pipe ends may first be placed in the position in which they are to be coupled, the frame, in the open condition, may then be put around the pipe ends, and then the frame can be closed. Thus, less or even no working space is required in an axial direction of the pipe ends during the placement of the coupling system. Specifically, the pipe ends do not, or at least minimally, need to be shifted back and forth in axial directions in order for the coupling to be mounted.

The coupling system prevents the pipe ends from moving away from each other in a pipeline direction even though no adhesive and/or solvent is needed. This makes the coupling system particularly environmentally-friendly, reduces the installation efforts, and also reduces manufacturing costs and efforts required to mount the coupling system. In addition, the coupling system can be used as a flexible coupling in the sense that it can move together with the pipe ends, so that it is, for example, suited to connect pipe ends buried in a material such as soil. Despite soil movements, a separation of the pipe ends from the coupling system is prevented. Further, stress concentrations are prevented because of the flexibility of the coupling system in that it can move together with the pipe ends.

Preferably, the open condition of the frame allows for the frame to be repositioned from a position remote from the pipeline lumen, to an embracing position, in which the frame is put around two pipe ends (while hardly moving, and more preferably without moving the pipe ends in the axial direction). Even more preferably, the open condition also allows for the frame to be converted from an embracing position to a withdrawn, i.e. non-embracing position. In other words, the open condition allows for a non-embracing state of the frame, wherein the frame is not positioned around the pipe ends or any other part of the pipes, and an embracing state, wherein the frame is put around the pipe ends. A transition between the two states is possible without having to substantially move the pipe ends, for example, while the pipe ends are put together for an extension of a pipeline lumen. Hence, the frame may be put around the pipe ends by a movement which is mainly effected in the radial, rather than in the axial direction of the pipe ends.

Preferably, the frame has at least two end portions and a central portion located between the end portions. At least one of the restrictor parts is located between one of the end portions and the central portion and comprises a restriction surface which extends radially inwardly in a direction from the central portion to said one of the end portions. The restriction surface is configured to allow an abutment with a protrusion of a pipe end.

The extension radially inwardly of the restriction surface may be oriented at any angle, preferably an angle larger than zero with respect to the pipeline direction. This ensures that at least a component of the contact force between a pipe end protrusion and the restriction surface is oriented in the pipeline direction, so that this force component may contribute to preventing the pipe end parts from moving away from each other in the pipeline direction.

Preferably, both restrictor parts comprise restriction surfaces as described above, so that a first and a second restriction surface are configured to allow an abutment with a first and a second protrusion of a first and a second pipe end, respectively.

According to a preferred embodiment, at least one of the restrictor parts comprises a receiving space for housing a protrusion of one or of both of the pipe ends.

When the restrictor part comprises a receiving space and the restriction surface, the restriction surface is preferably provided in the receiving space. For example, a protrusion of a pipe end can be housed in the receiving space in a formfitted state. The restriction surface of the receiving space may allow abutting against the protrusion so as to prevent the pipe ends from moving away from one another in the pipeline direction.

Preferably, the receiving space is an annular receiving space which has an inner shape and dimension for formfitting an outer annular part of the pipe end with an enlarged diameter, so as to prevent a relative movement between the pipe end and the frame when the pipe end is housed in the frame in the closed condition. Preferably, the inner shape and dimension of the annular receiving space are configured for formfitting the part of the pipe with the maximum diameter, which is preferably the part of the pipe comprising a protrusion or consisting of the protrusion. The formfitting between the annular part of a pipe end and an annular receiving space provides a particularly stable coupling, wherein relative movements between the pipe and the frame are prevented.

According to one embodiment, the receiving space is an annular receiving space which has an inner shape and dimension for housing an outer annular part of a pipe end with an enlarged diameter, so as to allow for a limited amount of relative movement between the pipe end with the outer annular part in the frame, when the pipe end is housed in the frame in the closed condition, and for variability in distance between two pipe ends within the limitation of the relative distance between the two pipe ends.

Preferably, the inner shape and dimension of the annular receiving space are configured to house the part of the pipe end with the largest diameter, preferably the part comprising a protrusion or consisting of the protrusion. Allowing for a limited amount of relative movement between the pipe end and the frame is especially advantageous as it reduces the stress applied to the coupling system when the pipe ends move. For example, when the connector pipes are buried in soil, a movement of the soil is less likely to result in a high concentration of stress acting on a particular portion of a pipe end or of the coupling system.

According to an embodiment, the frame is provided with a further annular receiving space with an inner shape and dimension for formfitting or housing an outer annular part of another pipe end with an enlarged diameter. This further annular receiving space may have any of the properties described with respect to the first annular cavities described above.

An annular receiving space of the type preventing any relative movement between a pipe end and a frame can be combined with another annular receiving space preventing any relative movement or with the type of annular receiving space allowing for a limited amount of relative movement between the pipe end and the frame. Likewise, one can also combine two types of cavities allowing for a limited amount of relative movement between the pipe ends.

According to a preferred embodiment, the receiving space is configured to receive outer annular parts of both pipe ends. This type of receiving space can be realized both in the form of a receiving space which prevents any relevant movement between the pipe end and the frame or in the form of a receiving space which allows a limited amount of relative movement between the pipe ends. Advantages of the receiving space configured to receive outer annular parts of both pipe ends is that the corresponding coupling system has an especially simple structure, it is easy to make, and it promotes easy and simple installation.

According to a preferred embodiment, the coupling system is free from a radial clamping mechanism. Prevention of the pipe ends from moving away from each other in a pipeline direction is hence provided even though a step of fastening a clamping mechanism in a radial direction need not be carried out upon mounting the coupling system. The mounting of the coupling system is therefore especially simple.

Preferably, the frame comprises at least two segments which are movable with respect to each other to change from the open to the closed condition of the frame, and preferably vice versa. This allows for an easy transformation from the open into the closed state, and preferably from the closed into the open state. In addition, the pipe ends do not, or at least hardly, need to be moved in an axial direction during placement of the coupling system.

According to an embodiment, the segments are fully separable from each other. However, the invention also comprises embodiments wherein the segments are not fully separable from each other, for example, when one segment is hinged to an other segment.

Fully separable segments structurally facilitate the mounting of the coupling system. The segments can be brought into position completely independently from one another, and when each of the segments is adequately positioned, the frame can be brought into the closed condition.

Preferably, the system further comprises a locking device for securing a position of the frame segments relative to each other when the system is in a closed state. The locking device may be a separate member or it may be separable from the frame. Alternatively, the locking device may be permanently connected to the frame, for example, in the form of being an integral part of the frame. Moreover, the locking device may be a single part or it may be a multi-part device.

The locking device simplifies the mounting of the coupling system. The segments can be moved relative to each other to bring the frame into the closed condition. They can then be secured relative to each other using the locking device. Hence, the locking device can also be placed in a convenient position during the movements of the two segments to bring the frame into the closed condition.

Preferably, the locking device comprises a ring member which is provided separately from the frame, and the frame preferably comprises a receiving surface on its outer periphery on which the ring member is snugly mountable. Preferably, the ring member is configured to be brought into frictional engagement with the receiving surface or to be formfit onto the receiving surface. Alternatively, the ring member is an elastic ring member. Moreover, it is also preferable when the coupling system comprises at least two ring members, i.e. at least one for each pipe end.

The ring member can first be mounted on a pipe end, before two pipe ends are put together for a continuation of a pipeline lumen. The coupling system can then be mounted and brought into the closed condition, and after that, the ring member can simply be slid from a position on the corresponding pipe end onto the outer periphery of a receiving surface of the frame. This way, the ring member can be tightly mounted to the frame, and frame segments can easily be secured in a position relative to each other using a very simple mechanism.

Preferably, the frame further comprises at least one locking protrusion on its outer periphery, the receiving surface being located adjacent to the locking protrusion and between the locking protrusion and an end portion of the frame.

The locking protrusion may abut against the ring member and thereby further prevent a displacement of the ring member. When a force tries to pull on a pipe end, a protrusion of a pipe end may abut against the corresponding restrictor part such as a restriction surface. The force acting from the protrusion of the pipe end onto the frame through the restrictor part may however be compensated by virtue of a counterforce acting from the ring member on the locking protrusion. In other words, the harder a force acts in order to pull a pipe end out of a coupling system, the harder the combination of the locking protrusion and the ring member prevents the separation.

According to a preferred embodiment, the frame comprises an outer periphery portion with a smaller diameter and a periphery with a larger diameter, as well as a transition portion connecting the two periphery portions. The transition portion comprises the restrictor surface on an inner side and the locking protrusion on an outer side.

The references to an inner and an outer side pertain to inner and outer sides in a radial direction, even if the transition portion extends in a direction which is oblique with respect to the radial direction. If the transition direction extends in the radial direction itself, the inner side may be understood as the side continuous with radial inner sides of adjacent peripheral portions, and the outer side may be understood as the opposite side.

The provision of the transition portion comprising the restrictor surface and the locking protrusion is advantageous, as both the restrictor surface and the locking protrusion can be realized with a single protuberance of the frame. In this way, the structure of the coupling system and especially of the frame is simplified.

Preferably, the coupling system is provided with sealing rings for ensuring that the pipeline lumen is free from leakage. This is especially advantageous as a leakage-free coupling can be ensured by an especially simple structure.

According to an embodiment, the system further comprises at least one socketed pipe end. It is preferable for the system to comprise two socketed pipe ends or at least a socketed and a non-socketed pipe end.

The coupling system may comprise a pipe part that is free from sockets and that has a diameter suitable for being sealingly connected with and between two pipe ends. For example, the pipe part can be slid inside the two pipe ends, in order to continue the pipeline lumen. During mounting of the coupling system, it is possible to place the pipe part in-between the two pipe ends in a first step. The frame, in an open condition, can then be put around the two pipe ends. Then, it can be brought into the closed condition.

Preferably, the system further comprises an adapter sleeve for mounting to a pipe end lacking a protrusion, the adapter sleeve comprising a protrusion extending radially outwardly. The adapter sleeve allows a pipe end without a protrusion to be transformed into a pipe end which is compatible with the coupling system. In other words, the adapter sleeve allows for the provision of a pipe end with a socket, i.e. making it into a pipe end with a protrusion.

Another aspect regards an assembly of a pipe end and a coupling system according to any one of the previously described embodiments. The pipe end is a socketed pipe end comprising an outer wall and, at at least one circumferential position on the outer wall, a protrusion that extends radially outwardly, the pipe end being housable in the closed condition, such that one of the first and second restrictor parts is allowed to abut against the protrusion of the pipe end.

The mentioned pipe end may either already have been manufactured as a socketed pipe end or it may be a pipe end comprising an adapter sleeve as described previously. Moreover, the assembly preferably comprises two pipe ends, rather than a single one.

According to another aspect, a method of connecting two pipe ends which are each provided with an outer wall and, at at least one circumferential position on the outer wall, a protrusion that extends radially outwardly, uses a coupling system according to any one of the previously described embodiments. The method comprises: putting the pipe ends together for a continuation of the pipeline lumen along a pipeline direction of the pipe ends, putting the frame of the coupling system around the two pipe ends and bringing the frame into the closed condition, such that the pipe ends are prevented from moving away from each other in the pipeline direction further than a maximum amount by inability of the protrusions to pass beyond the first and second restrictor parts, respectively.

The method covers embodiments wherein the pipe ends are prevented from any relative movement with respect to one another in the pipeline direction, i.e. wherein the maximum amount amounts to zero, but it also covers embodiments wherein some relative movement between the pipe ends is allowed.

Preferably, the method comprises the step of providing at least one pipe end with a socket by mounting an adapter sleeve to that pipe end. This increases the versatility of the method, as it can also be used to couple pipe ends wherein one or both of the pipe ends are not already socketed or at least not socketed in a manner compatible with the coupling system.

According to a preferred embodiment, the adapter sleeve is fixed on the pipe end by gluing or screwing. However, the invention also pertains to methods wherein the adapter sleeve is fixed on the pipe end by any other method for fixation known in this technical field to the skilled person.

When the method of connecting two pipe ends is used with a coupling system comprising a locking device for securing a position of frame segments relative to each other when the system is in a closed condition, the method preferably further comprises the step of securing the position of the frame segments relative to each other using the locking device.

When the method is used with a coupling system, wherein the locking device comprises a ring member, as described previously, the method preferably further comprises the steps of: positioning the ring member around the first pipe end, prior to the step of putting the frame around the two pipe ends, and moving the ring member from a position on the first pipe end onto the receiving surface of the frame, and snugly mounting the ring member on the receiving surface.

The previously-described further steps may also be carried out for both pipe ends, wherein (at least) two ring members are provided. These embodiments of the method are especially advantageous as they allow for a simple and efficient method of connecting two pipe ends in a stable and flexible manner.

Preferably, the step of positioning the ring member around the first pipe end is carried out prior to the step of putting the pipe ends together. Analogously, a preferable step of positioning another ring member around the second pipe end may be carried out prior to the step of putting the pipe ends together.

The step of putting the pipe ends together preferably involves positioning a pipe part that is free from sockets and has a diameter suitable for being sealingly connected with two pipe ends between the pipe ends.

Additional advantages and features of the present invention, that can be realized on their own or in combination with one or several features discussed above, insofar as the features do not contradict each other, will become apparent from the following description of preferred embodiments.

### BRIEF DESCRIPTION OF THE DRAWINGS

Preferred embodiments are depicted in the accompanying drawings, in which:

FIG. 1A depicts an embodiment of a coupling system;

FIG. 1B is a sectional view of parts of the coupling system of FIG. 1A;

FIG. 1C is an enlarged view of part A of FIG. 1B;

FIG. 2A is a sectional view of an embodiment of a coupling system;

FIG. 2B is an outside view of the coupling system of FIG. 2A;

FIG. 3A is a sectional view of an embodiment of a coupling system preventing any relative movement between two pipe ends;

FIG. 3B is a sectional view of an embodiment of a coupling system allowing for some relative movement between pipe ends;

FIG. 4 is a perspective view of an embodiment of a coupling system;

FIG. 5 is a sectional view of the coupling system of FIG. 4;

FIG. 6A is a perspective view of an embodiment of a coupling system comprising a sleeve member;

FIG. 6B is a partial sectional view of the coupling system of FIG. 6A;

FIG. 7A is a perspective view of an embodiment of a coupling system comprising a sleeve member; and

FIG. 7B is a partial sectional view of the coupling system of FIG. 7A;

Like parts are denoted with like reference signs throughout the figure.

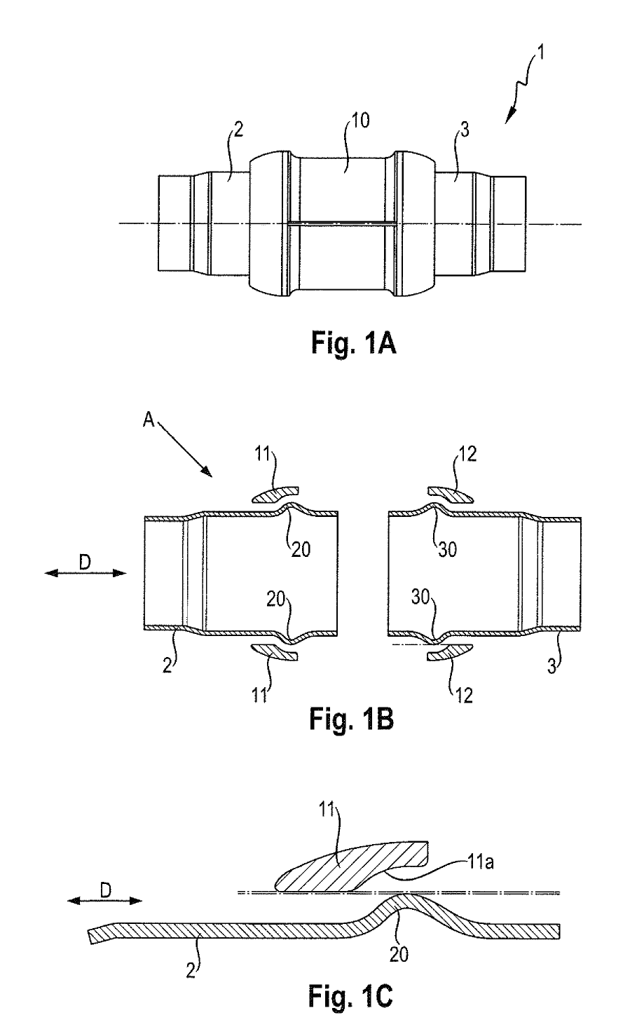

FIG. 1A is an outside side view of an embodiment of a coupling system 1.

The system 1 comprises a frame 10 which can adopt an open and a closed position. FIG. 1A shows the closed condition of frame 10 wherein the two pipe ends 2, 3 are housed in the frame 10. The coupling system 1 couples a first pipe end 2 and a second pipe end 3 so as to continue the pipeline lumen.

FIG. 1B is a sectional view of some essential parts of the coupled state of the coupling system 1 depicted in FIG. 1A.

In the case of the embodiment depicted in FIGS. 1A to 1C, the first and the second pipe ends 2, 3 are themselves not part of the coupling system 1. However, the invention also comprises embodiments wherein one or both of the pipe ends are a part of the coupling system, i.e. wherein the coupling system comprises one or two pipe ends.

The frame 10 comprises a first restrictor part 11 and a second restrictor part 12. The first and second restrictor parts 11, 12 are integrally formed with the frame 10 and extend annularly along the inner circumference of the frame 10. However, the present invention also comprises embodiments wherein the restrictor parts are provided as separate members which are not part of the frame.

The first restrictor part 11 is configured to abut against the first protrusion 20 of the first pipe end 2, whereas the second restrictor part 12 is configured to abut against a second protrusion 30 of the second pipe end 3. The pipe ends 2, 3 are limited in moving away from each other any further in the pipeline direction D by an abutment of the protrusions 20, 30 against the first and second restrictor part 11, 12, respectively.

FIG. 1C is an enlarged view of the part of FIG. 1B denoted with the arrow labelled ‘A’ in FIG. 1B. There is no need to

use an adhesive and/or a solvent to mount a coupling system 1 as a movement away from each other of the pipe ends 2, 3 in the pipeline direction D is prevented by the abutment of the protrusions 20, 30 and the restrictor parts 11, 12. This makes it particularly environment-friendly. It also reduces manufacturing costs, as well as manhours required to mount the coupling system.

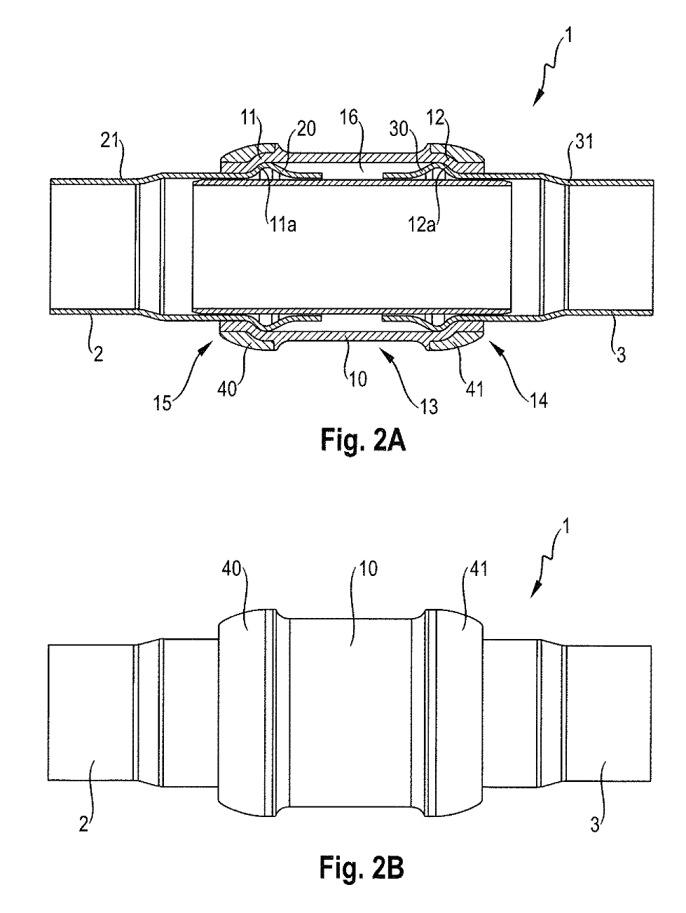

FIG. 2A shows a sectional view of an embodiment of the coupling system 1 according to an embodiment of the present invention. The coupling system 1 couples first and second pipe ends 2, 3 which are each provided with an outer wall 21, 31, respectively, and, at one circumferential position on the outer wall 21, 31, with a protrusion 20, 30 that extends radially outwardly.

The coupling system 1 comprises a frame 10 which can adopt an open and a closed condition. In the open condition, the frame 10 can be put around the two pipe ends 2, 3 when put together for a continuation of the pipeline lumen. In the closed position, the frame 10 houses the two pipe ends 2, 3. This is the state shown in FIG. 2A.

FIG. 2B shows an outside view of the coupled state of the coupling system 1 and the pipe ends 2, 3.

The frame 10 comprises first and second restrictor parts 11, 12 which are configured to allow abutting against the protrusions 20, 30 of the opposite pipe ends 2, 3 in the closed condition of the frame 10. The frame 10 comprises a central portion 13 and end portions 14, 15. The restrictor parts 11, 12 are each located between one of the end portions 14, 15 and the central portion 13, respectively.

The restrictor parts 11, 12 each comprise a restriction surface 11a, 12a, respectively. For comparison, a restriction surface 11a is also provided for the embodiment of FIG. 1, as shown in FIG. 1C.

The restriction surfaces 11a, 12a of the embodiment of FIGS. 2A and 2B extend radially inwardly at an oblique angle with respect to the pipeline direction. More specifically, they extend in a direction from the central portion 13 towards the corresponding one of the end portions 14, 15, respectively. The restriction surfaces 11a, 12a are configured to allow abutment with the corresponding protrusions 20, 30 of the pipe ends 2, 3.

The frame 10 of the embodiment depicted in FIGS. 2A and 2B comprises an annular receiving space 16 for housing both of the protrusions 20, 30 of the opposing pipe ends 2, 3. However, the present invention also includes embodiments wherein the frame comprises at least two cavities each for housing one protrusion of one of the pipe ends.

The coupling system 10 of FIG. 2 is free of a radial clamping mechanism. Therefore, the separation of pipe ends in the pipeline direction can be prevented without having to include the step of fastening a mechanical clamping mechanism in the radial direction.

The coupling system 10 further comprises a first and a second locking device 40, 41 for securing the position of the frame 10 in the closed state. In the present case, the locking devices 40, 41 are separable from the frame 10, but the present invention also comprises embodiments wherein a locking device is formed as an integral part of the frame.

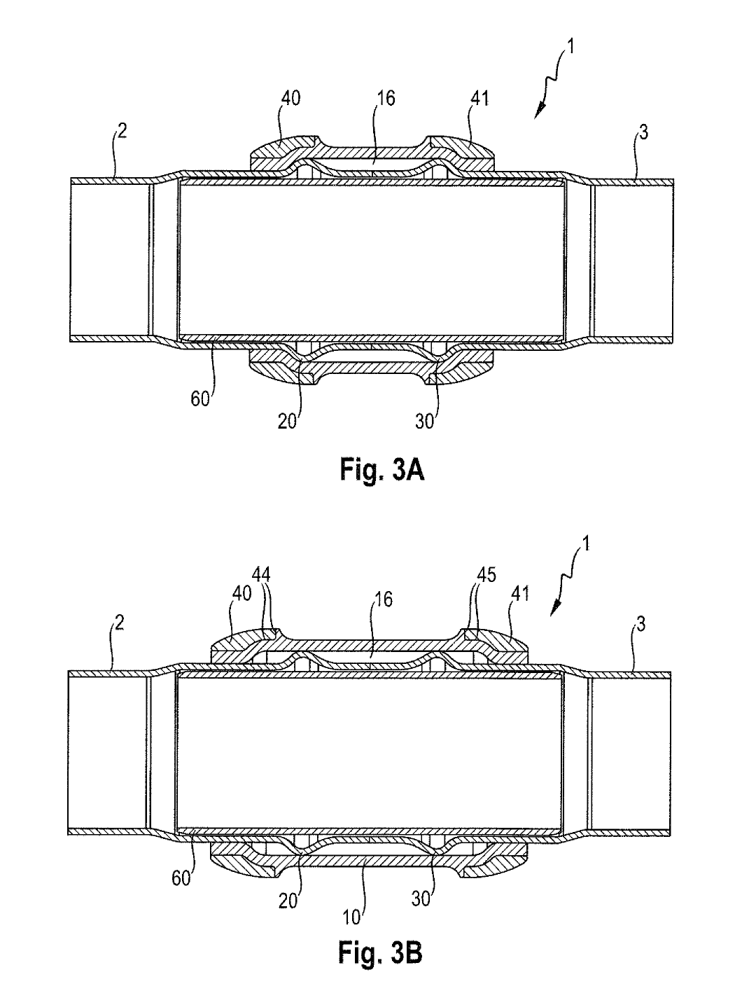

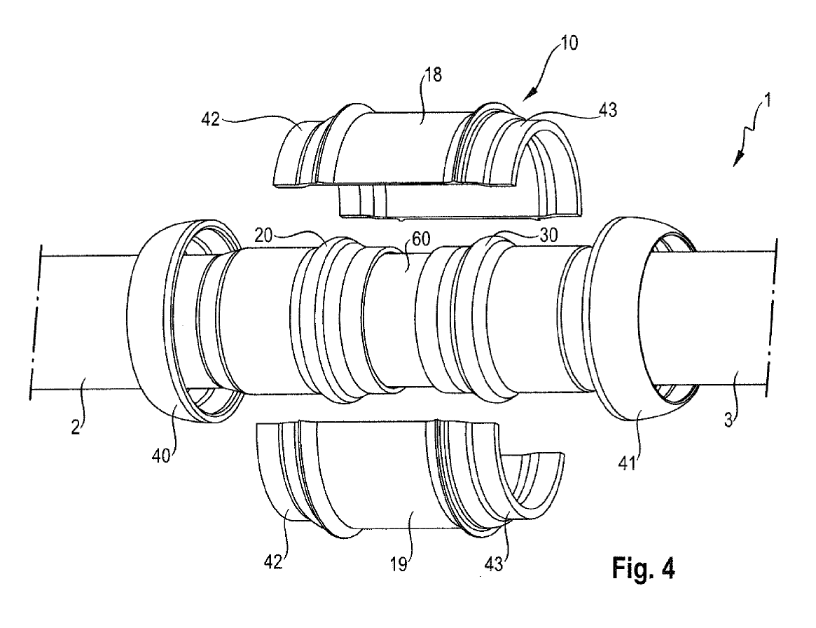

FIG. 3A is a sectional view of an embodiment of a coupling system 1. This embodiment allows no, or at least hardly any, relative movement between the pipe ends 2, 3 when the frame 10 is in the closed condition with the pipe ends 2, 3 housed in the frame 10. Nevertheless, the coupling system 1 is flexible in the sense that it can move together with the pipe ends 2, 3. Hence, it is particularly suited to connect pipe ends 2, 3 which will be buried in materials which move, such as soil. Despite movements of the material (e.g. soil), a separation of the pipe ends 2, 3 from the coupling system 1 is prevented.

The two pipe ends 2, 3 abut against each other and are received in an annular receiving space 16 which has an inner shape and dimensions for formfitting outer annular parts of the pipe ends 2, 3 with an enlarged diameter, i.e. the pipes with the protrusions 20, 30. This embodiment of a coupling system 1 provides an especially stable coupling with hardly any or no slack regarding relative movements between the pipe ends 2, 3.

In contrast to the embodiment of FIG. 3A, the coupling system 1 of FIG. 3B permits a limited amount of relative movement between the pipe ends 2, 3 when they are housed in the frame 10 in a closed condition. The coupling system 1 of FIG. 3B has an annular receiving space 16 with an inner shape and dimensions for housing the outer annular parts of both pipe ends 2, 3 with an enlarged diameter, i.e., the parts with the protrusions 20, 30. Variability in the distance between the two pipe ends 2, 3 within the imposed limitation of relative distance is permitted. In this way, some movement of the pipe ends can be avoided by virtue of relative displacements of the pipe ends 2, 3 in the coupling system 1. Thus, stress concentrations are prevented from occurring on parts of the pipe ends 2, 3 and/or the coupling system 1. This is especially advantageous when pipes are buried in a material which can move (e.g. soil).

Moreover, both the embodiments of FIGS. 3A and 3B comprise locking devices 40, 41 for securing a position of the frame 10 in the closed condition. Both embodiments comprise a pipe part 60 that is free from sockets and that has a diameter suitable for being sealingly connected with and between the two pipe ends 2, 3. Before connecting the pipe ends 2, 3, the pipe part 60 is inserted in-between, in order to continue the pipeline lumen even when a small distance separating the two pipe ends 2, 3 remains present. This is especially advantageous for an embodiment such as the one of FIG. 3B which permits some relative movement.

FIG. 4 is a perspective view of an embodiment of a coupling system 1. The system 1 is used to couple two socketed pipe ends 2, 3 having at at least one circumferential position on their outer walls protrusions 20, 30 that extend radially outwardly.

The system 1 comprises a sleeve member 60 which is connected with and between the two pipe ends 2, 3. In addition, the system 1 comprises a frame 10 consisting of two segments, a first segment 18 and a second segment 19. FIG. 4 depicts the frame 10 in an open condition wherein the first segment 18 and the second segment 19 are fully separated. However, the present invention also comprises embodiments wherein the segments 18, 19 are not fully separable but merely movable with respect to one another, in order to change from the open to the closed condition of the frame 10 and vice versa.

FIG. 4 shows a state during mounting the coupling system 1. Sleeve member 60 has been brought into place, and the pipe ends 2, 3 to be coupled have been put together for a continuation of a pipeline lumen. The frame 10 is in an open condition wherein the frame segment 18, 19 can be put around the two pipe ends 2, 3 and brought together to form the closed condition.

The system 1 further comprises locking devices 40, 41. The locking devices 40, 41 have been previously slid onto the opposing pipe ends 2, 3, and they can be slid from the position shown in FIG. 4 onto corresponding receiving surfaces 42, 43 on the frame 10. The locking devices 40, 41 then secure the position of the frame segments 18, 19 relative to each other when the system 1 is in a closed condition.

To install the coupling system 1, the frame segments 18, 19 are, in the open condition of the frame 10, brought together, i.e. they are moved towards each other in a radial direction of the pipe ends 2, 3, until they embrace the pipe ends 2, 3. Put differently, the frame 10 is converted from a withdrawn state, in which the frame 10 is withdrawn from the pipeline lumen, to an embracing state, in which the frame segments 18, 19 are brought together, so that the frame 10 is put around the pipe ends. The frame segments 18, 19 then form a shell which encloses the pipe ends 2, 3. The pipe ends 2, 3 need not be moved in the axial direction for the frame 10 to be transformed from the open into the closed condition as the frame segments 18, 19 can be brought into place by a movement which is mainly effected in the radial, rather than in the axial direction of the pipe ends.

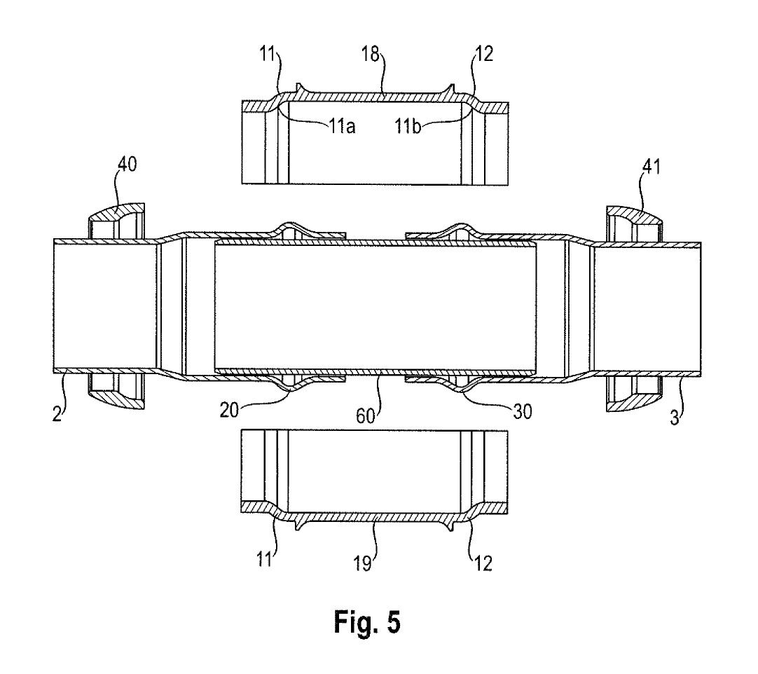

FIG. 5 depicts a sectional view of the coupling system 1 shown in FIG. 4. The sectional view also shows the restrictor parts 11 and 12 of the frame 10 which comprise restriction surfaces 11a, 11b configured to be brought into abutment with the protrusions 20, 30 at the pipe ends 2, 3.

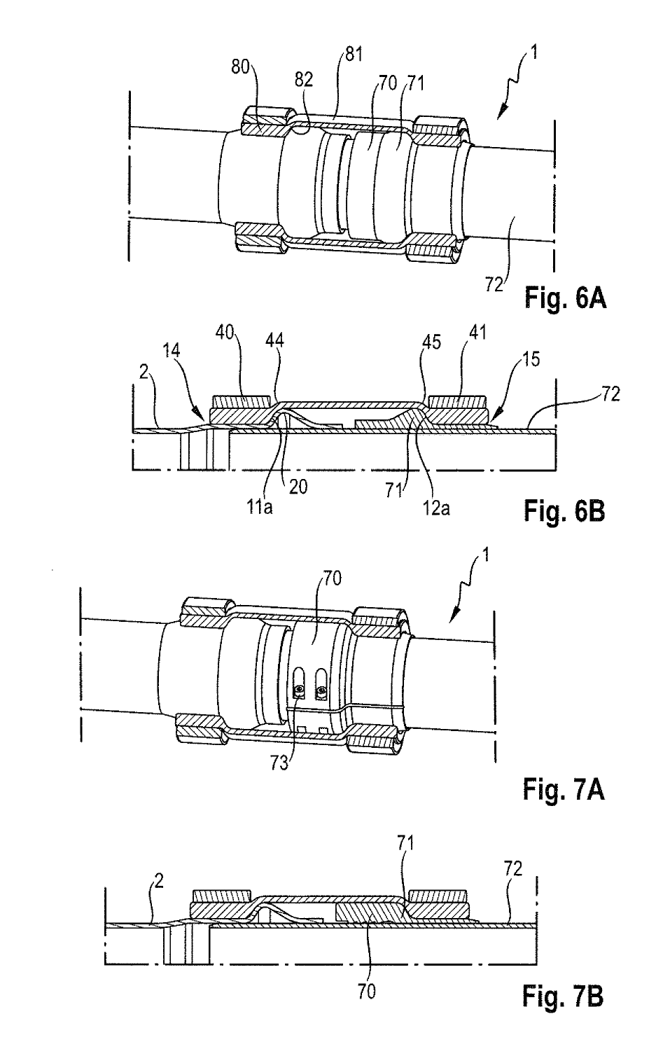

FIG. 6A is a perspective view of an embodiment of the coupling system 1 which comprises an adapter sleeve 70 which is mounted to a pipe end which lacks a protrusion. The adapter 70 comprises a protrusion 71 extending radially outwardly and makes the pipe ends 72 compatible with the coupling system. In the case of FIG. 6A, merely one pipe end is provided with an adapter sleeve 70, but the invention also includes embodiments wherein both pipe ends are provided with adapter sleeves.

FIG. 6B is a sectional view of a pipe of the embodiment of the coupling system 1 of FIG. 6A. FIG. 6B depicts a socketed pipe end 2 with the protrusion 20 and a pipe end 72 provided with the sleeve member 70 with a protrusion 71. In this way, the pipe end 72 also mimics a socketed pipe end. The coupling system 1 of FIG. 6 can also be provided as a replacement or a repair tool kit, in order to replace other couplings even when the corresponding pipe ends would seemingly not seem compatible with the system according to the present invention.

The system 1 depicted in FIGS. 6A and 6B further comprises elastic ring members as locking devices 40, 41 for securing the frame 10 in place in the closed condition. The system 1 also comprises locking protrusions 44, 45 on the outer periphery of the frame 10, wherein the receiving surfaces 11a, 12a are located adjacent the locking protrusions 44, 45 and between the locking protrusions 44, 45 and the end portions 14, 15 at the frame 10.

The locking protrusion 44 may abut against the ring member 40 and thereby further prevent a displacement of the ring member 40. When a force tries to pull on a pipe end 2, the protrusion 20 of the pipe end 2 may abut against the corresponding restrictor part 11 with a restriction surface 11a. However, the forces acting from the protrusion 20 on the pipe end 2 onto the frame 10 may be at least partially compensated by counterforces acting from the ring member 40 onto the locking protrusion 44. The harder a force acts in order to pull the pipe end 2 out of the coupling system 1, the harder the locking protrusion 44 and the ring member 40 prevent the separation. An analogous view holds for the other pipe end 72.

The frame 10 of this embodiment comprises an outer periphery portion 80 with a smaller diameter, a periphery portion 81 with a larger diameter, as well as a transition portion 82 mediating between the two periphery portions 80, 81. The transition portion 82 comprises the restrictor surface 11a on an inner side and a locking protrusion 44 on the outer side.

In addition, the sleeve member 70 of this embodiment is glued to the pipe end 72 and is made from PVC, although the invention is not limited to this material for a sleeve member. Such an implementation of a sleeve member is especially cost-efficient.

FIG. 7A discloses a similar embodiment of a coupling system 1 which also comprises a sleeve member 70. FIG. 7B is a partial sectional view of the coupling system of FIG. 7A. However, this embodiment uses a stainless steel clamp. This is advantageous as the use of an adhesive may be avoided. This embodiment works with a screw mechanism 73 for fastening the sleeve member 70. However, the invention is not limited to any of the disclosed fixation mechanisms for a sleeve member, and the skilled person will readily acknowledge possible variations.

Many additional variations and modifications are possible and are understood to fall within the framework of the invention.

1. A coupling system for coupling two pipe ends which are each provided with an outer wall and, at at least one circumferential position on the outer wall, a protrusion that extends radially outwardly,
wherein the system comprises a frame which can adopt an open condition and a closed condition, the open condition allows the frame to be put around the two pipe ends when put together for a continuation of a pipeline lumen, the frame in the closed condition being configured to house the two pipe ends when put together for a continuation of the pipeline lumen,
wherein the frame comprises at least a first and a second restrictor part, the first and second restrictor parts being configured to allow an abutment against the protrusions of the opposite pipe ends in the closed condition of the frame, so that the pipe ends are at least limited from moving away from each other in a pipeline direction by inability of the protrusions to pass beyond the first and second restrictor parts, respectively.

2. A coupling system according to claim 1, the frame having a central portion and end portions,
wherein at least one of the restrictor parts is located between one of the end portions and the central portion,
and wherein said one of the restrictor parts comprises a restriction surface which extends radially inwardly in a direction from the central portion to said one of the end portions, the restriction surface being configured to allow the abutment.

3. A coupling system according to claim 1, wherein at least one of the restrictor parts comprises a receiving space for housing a protrusion of one or of both of the pipe ends.

4. A coupling system according to claim 3, wherein the receiving space is an annular receiving space which has an inner shape and dimension for formfitting an outer annular part of a pipe end with an enlarged diameter, so as to prevent a relative movement between the pipe end and the frame when the pipe end is housed in the frame in the closed condition.

5. A coupling system according to claim 3, wherein the receiving space is an annular receiving space which has an inner shape and dimension for housing an outer annular part of a pipe end with an enlarged diameter, so as to permit a limited amount of relative movement between the pipe end with the outer annular part and the frame, when the pipe end is housed in the frame in the closed condition, and for variability in distance between two pipe ends within a limitation of the relative distance between the two pipe ends.

6. A coupling system according to claim 4, wherein the frame is provided with a further annular receiving space with an inner shape and dimension for formfitting or housing an outer annular part of another pipe end with an enlarged diameter.

7. A coupling system according to claim 3, wherein the receiving space is configured to receive outer annular parts of both pipe ends.

8. A coupling system according to claim 1, wherein the coupling system is free from a radial clamping mechanism.

9. A coupling system according to claim 1, wherein the frame comprises at least two segments which are movable with respect to each other to change from the open to the closed condition of the frame, and preferably vice versa.

10. A coupling system according to claim 9, wherein the segments are fully separable from each other.

11. A coupling system according to claim 9, wherein the system further comprises a locking device for securing a position of the frame segments relative to each other when the system is in the closed condition.

12. A coupling system according to claim 11, wherein the locking device comprises a ring member, provided separately from the frame, and the frame comprises a receiving surface on its outer periphery on which the ring member is snugly mountable.

13. A coupling system according to claim 12, wherein the ring member is configured to be brought into frictional engagement with the receiving surface or to be form-fit on the receiving surface.

14. A coupling system according to claim 12, wherein the frame further comprises at least one locking protrusion on its outer periphery, the receiving surface located adjacent to the locking protrusion and between the locking protrusion and an end portion of the frame.

15. A coupling system according to claim 2, wherein the frame comprises an outer periphery portion with a smaller diameter and a periphery portion with a larger diameter, as well as a transition portion mediating between the two periphery portions, wherein the transition portion comprises the restrictor surface on an inner side and the locking protrusion on an outer side.

16. A coupling system according to claim 1, wherein the coupling system is provided with sealing rings for ensuring that the continued pipe lumen is free from leakage.

17. A coupling system according to claim 1, wherein the system further comprises at least one socketed pipe end.

18. A coupling system according to claim 1, further comprising a pipe part that is free from sockets and that has a diameter suitable for being sealingly connected with and between two pipe ends.

19. A coupling system according to claim 1, wherein the system further comprises an adapter sleeve for mounting to a pipe end lacking a protrusion, the adapter sleeve comprising a protrusion extending radially outwardly.

20. An assembly of a pipe end and a coupling system according to claim 1, wherein the pipe end is a socketed pipe end comprising an outer wall and, at at least one circumferential position on the outer wall, a protrusion that extends radially outwardly, the pipe end being housable in the frame in the closed condition, such that one of the first and second restrictor parts is allowed to abut against the protrusion of the pipe end.

21. Method of connecting two pipe ends which are each provided with an outer wall and, at at least one circumferential position on the outer wall, a protrusion that extends radially outwardly, comprising the steps of:
providing a coupling system with a frame which can adopt an open condition and a closed condition and comprising at least a first and a second restrictor part, the first and second restrictor parts being configured to allow an abutment against the protrusions of opposite pipe ends in the closed condition of the frame,
putting the pipe ends together for a continuation of a pipeline lumen along a pipeline direction of the pipe ends; and
putting the frame in the open condition around the two pipe ends and bringing the frame into the closed condition, so that the frame in the closed condition houses the two pipe ends and that the pipe ends are at least limited from moving away from each other in a pipeline direction by inability of the protrusions to pass beyond the first and second restrictor parts, respectively.

22. Method of connecting two pipe ends according to claim 21, wherein the step of providing the coupling system is a step of providing a coupling system comprising an adapter sleeve for mounting to a pipe end lacking a protrusion, the adapter sleeve comprising a protrusion extending radially outwardly, the method further comprising the step of providing at least one pipe end with a socket by mounting the adapter sleeve to that pipe end.

23. Method of connecting two pipe ends according to claim 22, wherein the adapter sleeve is fixed on the pipe end by gluing or screwing.

24. Method of connecting two pipe ends according to claim 21, wherein the system further comprises at least two segments which are movable with respect to each other to change from the open to the closed condition and a locking device, the method further comprising the step of securing a position of the frame segments relative to each other using the locking device.

25. Method of connecting two pipe ends according to claim 21, wherein the locking device comprises a ring member, provided separately from the frame, and the frame comprises a receiving surface on its outer periphery, the method further comprising the steps of:
positioning the ring member around a first pipe end, prior to the step of putting the frame around the two pipe ends; and
moving the ring member from a position on the first pipe end onto the receiving surface of the frame to snugly mount the ring member on the receiving surface.

26. Method of connecting two pipe ends according to claim 25, wherein the step of positioning the ring member around the first pipe end is carried out prior to the step of putting the pipe ends together.

27. Method of connecting two pipe ends according to claim 21, wherein the step of putting the pipe ends together involves positioning a pipe part that is free from sockets and that has a diameter suitable for being sealingly connected with two pipe ends between the pipe ends.

28. A coupling system according to claim 14, wherein the frame comprises an outer periphery portion with a smaller diameter and a periphery portion with a larger diameter, as well as a transition portion mediating between the two periphery portions,
wherein the transition portion comprises the restrictor surface on an inner side and the locking protrusion on an outer side.
